(19) United States
(12) Patent Application Publication
(10) Pub. No.: US 2025/0144705 A1
(43) Pub. Date: May 8, 2025

(54) ADDITIVE CASTING DEPOSITION SYSTEM AND METHOD

(71) Applicant: Magnus Metal Ltd., Revadim (IL)

(72) Inventors: Gil LAVI, Ness Ziona (IL); Ido HOLCMAN, Rehovot (IL)

(21) Appl. No.: 18/837,615

(22) PCT Filed: Mar. 1, 2023
(86) PCT No.: PCT/IL2023/050211

§ 371 Date: Aug. 12, 2024

Related U.S. Application Data
(60) Provisional application No. 63/315,096, filed on Mar. 1, 2022.

(51) Int. Cl. B22D 23/00; B22C 9/22; B28B 1/00; B33Y 10/00; B33Y 30/00

(52) U.S. Cl. CPC B22D 23/00; B22C 9/22; B33Y 10/00; B33Y 30/00; B28B 1/001

(57) ABSTRACT

A casting system for casting an object, the system comprises a mold powder provision system, a mold binder dispensing system, a mold powder removal system, and a molten metal processing system. The casting system is configured to additively produce multiple production layers in a build unit, one currently-produced production layer after the other. For each currently-produced production layer, the mold powder provision system is configured to provide one or more current mold powder layers; the mold binder dispensing system is configured to form one or more current metal-facing zones of the mold regions within each of the one or more current mold powder layers by selectively dispending one or more binders that bond some mold powder particles of the current mold powder layer; the mold powder removal system is configured to remove mold powder particles located within a certain area of the current mold powder layers, the certain area is defined by the current metal facing zones of the mold regions; and the molten metal processing system is configured to form one or more current object regions of the currently-produced production layer by providing molten metal to the certain area.

### CROSS REFERENCE TO RELATED APPLICATIONS

This application claims priority from U.S. provisional patent application 63/315,096, filed Mar. 1, 2022, which is incorporated herein by reference.

### TECHNICAL FIELD OF THE INVENTION

The application generally relates to the field of casting parts. More specifically, the application relates to the field of the additive casting of parts.

### BACKGROUND OF THE INVENTION

The majority of the world's demand for the metal cast is addressed nowadays by traditional casting techniques. While automation solutions are applied, traditional casting involves the global production of molds and the global application of molten metal. For example, additive manufacturing techniques are used for mold fabrication with the implementation of mold curing, sintering, or otherwise mold hardening as a global operation before metal pouring. Molten metal is poured into fully-fabricated molds.

Additive manufacturing techniques such as binder jetting 3D (three-dimensional) printing are employed in manufacturing molds for casting and for metal binder jetting. Other metal additive manufacturing for industrial use is often associated with Laser or Electron Beam Mold powder Bed Fusion technologies. New additive manufacturing techniques are currently being investigated and are not widely implemented for industrial use. Typically, fabrication throughput is limited, and scaling to large part sizes and weight is challenging.

There is a need for an additive metal casting system and method that facilitates high-volume manufacturing at the desired cost and throughput.

### SUMMARY OF THE INVENTION

According to an aspect of the invention, there is provided a casting system and a method for casting.

According to an aspect of the present disclosure there is provided a casting system for casting an object, wherein the system comprises: a mold powder provision system; a mold binder dispensing system; a mold powder removal system; and a molten metal processing system; wherein the casting system is configured to additively produce multiple production layers in a build unit, one currently-produced production layer after the other; wherein for each currently-produced production layer: the mold powder provision system is configured to provide one or more current mold powder layers; the mold binder dispensing system is configured to form one or more current metal-facing zones of the mold regions within each of the one or more current mold powder layers by selectively dispending one or more binders that bond some mold powder particles of the current mold powder layer; the mold powder removal system is configured to remove mold powder particles located within a certain area of each of the one or more current mold powder layers, the certain area is defined by at least some of the one or more current metal facing zones of the mold regions; and the molten metal processing system is configured to form one or more current object regions of the currently-produced production layer by providing molten metal to the certain area.

The mold powder removal system may be configured to (1) remove the mold powder particles from the certain area and maintain loose mold powder at one or more external zones which are external to the one or more current metal facing zones of the mold regions; (2) remove the mold powder particles from the certain area and prevent from removing loose mold powder at one or more external zones of the one or more current mold powder layers that are external to the one or more metal-facing zones of the current mold regions; (3) provide suction directly above the certain area and prevent suction directly above loose mold powder located outside the certain area; (4) remove the mold powder particles from the certain area of a single mold powder layer; or (5) remove the mold powder particles from the certain area of multiple mold powder layers. The mold powder removal system may further comprise a suction conduit that is configured to be lowered into the certain area during powder suction.

The molten metal processing system may be configured to (1) form the one or more current object regions of the currently-produced production layer by depositing a layer of molten metal in the certain area; (2) form the one or more current object regions of the currently-produced production layer by performing a single molted metal deposition iteration to the certain area; (3) form the one or more current object regions of the currently-produced production layer by performing multiple molted metal deposition iterations to the certain area; (4) form the one or more current object regions of the currently-produced production layer by depositing multiple layers of molten metal in the certain area; (5) form the one or more current object regions of the currently-produced production layer by applying a Preparation-Deposition-Post treatment for depositing the molten metal to the certain area; and/or (6) convert metal mold powder to the molten metal.

The molten metal processing system may further comprise at least one induction coil unit; and wherein the casting system may further comprise a movement system configured to provide a relative movement between (i) the build unit and (ii) the molten metal processing system. The movement system may be configured to introduce the relative movement along a progression direction while the at least one induction coil unit is configured to heat a portion of the molten metal processing system to deposit metal in a sub-area of the certain area to form a currently-produced layer of molten metal and at least one of (1) pre-heat a sub-area of a previously-produced layer of molten metal, and (2) post-heat a sub-area of a currently-produced layer of molten metal.

The casting system may further comprise a movement system configured to introduce relative movements between at least (1) the mold powder provision system, mold binder dispensing system and the mold powder removal system and (2) the build unit.

At least one of the mold powder provision system, mold binder dispensing system and the mold powder removal system may be thermally shielded at least in part.

At least one of the mold powder provision system, mold binder dispensing system and the mold powder removal system may be equipped with a controllable cooling unit.

The casting system may further comprise a controller in data communication with at least the mold powder provision system, mold binder dispensing system, the mold powder removal system, the molten metal processing system and the build unit, wherein the controller is configured to dynamically control the controllable cooling unit responsive to temperature sensor readings of one or more areas of the build unit. The controller may be configured to maintain at least the mold binder dispensing system at a desired working temperature. The desired working temperature may be in a range of room temperature to 200 deg. Celsius. The controller may be configured to (1) adjust a cooling rate of the controllable cooling unit; and/or (2) adjust a property of cooling rate.

The mold binder dispensing system may comprise one or more binder print heads and one or more binder storages, each binder storages is in fluid communication with at least one of the one or more binder print heats. Each of the one or more binder print heads may be configured to dispense one or more binders.

The mold binder dispensing system may comprise a controllable cooling unit in data communication with a controller. The controllable cooling unit may be controlled by the controller such that (1) a working temperature of the one or more binder print head is maintained, wherein the working temperature is selected based on one or more properties of the one or more binders; and/or (2) a working temperature of the one or more binder storages is maintained, wherein the working temperature is selected based on one or more properties of the one or more binders.

The controller may be responsive to (1) readings of a temperature sensor sensing a temperature beneath the one or more print heads; and/or (2) readings of one or more temperature sensors sensing one or more temperatures of one of the certain area and the metal facing zone of the mold region.

According to an aspect of the present disclosure, there is provided a method for casting an object, wherein the method comprises: additively producing multiple production layers, one currently-produced production layer after the other; wherein for each currently-produced production layer: providing, by a mold powder provision system, one or more current mold powder layers; forming, by a mold binder dispensing system, one or more current metal-facing zones of the mold regions within each of the one or more current mold powder layers by selectively dispending one or more binders that bond some mold powder particles of the current mold powder layer; removing, by a mold powder removal system, mold powder particles located within a certain area of the one or more current mold powder layers, the certain area is defined by at least some of the one or more current mold regions; and forming, by a molten metal processing system, one or more current object regions of the currently-produced production layer by providing molten metal to the certain area.

The one or more current mold powder layers may be multiple current mold powder layers. The multiple layers may comprise a first production layer that is formed on a build unit.

The removing of the mold powder particles from the certain area may comprise (1) maintaining loose mold powder at one or more external zones which are external to the one or more current metal facing zones of the mold regions; (2) preventing from removing loose mold powder at one or more external zones of the one or more current mold powder layers that are external to the one or more metal-facing zones of the current mold regions; (3) utilizing flow control elements to provide suction directly above the certain area and prevent suction directly above loose powder located outside the certain area; (4) utilizing a suction conduit that is configured to be lowered into the certain area during powder suction; (5) removing the mold powder particles from the certain area of a single mold powder layer; and/or (6) removing the mold powder particles from the certain area of multiple mold powder layer.

The forming of the one or more current object regions of the currently-produced production layer may comprise (1) depositing a layer of molten metal in the certain area; (2) performing a single molted metal deposition iteration to the certain area; (3) performing multiple molted metal deposition iterations to the certain area; (4) depositing multiple layers of molten metal in the certain area; (5) applying a Preparation-Deposition-Post treatment for depositing the molten metal to the certain area.

The method may comprise introducing, by a movement system, a relative movement between (i) a build unit and (ii) the molten metal processing system.

The method may comprise heating, by at least one induction coil unit and during the introducing of the relative movement, a portion of the molten metal processing system to deposit the molten metal in a sub-area of the certain area to form a currently-produced layer of molten metal, performing at least one of (1) pre-heating a sub-area of a previously-produced layer of molten metal, and (2) post-heating a sub-area of a currently-produced layer of molten metal. The method may comprise converting, by the metal processing system, metal mold powder to the molten metal.

The method may further comprise thermally shielding at least one of the mold powder provision system, mold binder dispensing system and the mold powder removal system at least in part.

The method may further comprise cooling at least one of the mold powder provision system, mold binder dispensing system and the mold powder removal system by a controllable cooling unit. The cooling may comprise (1) dynamically controlling the controllable cooling unit by a controller responsive to temperature sensor readings of one or more areas of the build unit; (2) maintaining at least the mold binder dispensing system at a desired working temperature; (3) adjusting a cooling rate of the controllable cooling unit; (4) adjusting a property of a cooling rate of the controllable cooling unit; (5) responding to readings of a temperature sensor sensing a temperature beneath the one or more print heads; or (6) responding to readings of one or more temperature sensors sensing one or more temperatures of one of the certain area and the metal facing zone of the mold region. The working temperature may be in a range of room temperature to 200 deg. Celsius. The working temperature may be selected based on one or more properties of the one or more binders

According to an aspect of the present disclosure, there is provided a non-transitory computer readable medium for casting an object, wherein the non-transitory computer readable medium stores instructions for: additively producing multiple production layers, one currently-produced production layer after the other; wherein for each currently-produced production layer: providing, by a mold powder provision system, one or more current mold powder layers; forming, by a mold binder dispensing system, one or more current metal-facing zones of the mold regions within each of the one or more current mold powder layers by selectively dispending particles of one or more binders that bond some mold powder particles of the current mold powder layer; removing, by a mold powder removal system, mold powder particles located within a certain area of the one or more current mold powder layers, the certain area is defined by at least some of the one or more current mold regions; and forming, by a molten metal processing system, one or more current object regions of the currently-produced production layer by providing molten metal to the certain area.

According to yet another aspect of the present disclosure, there is provided a casting system for casting an object, wherein the system comprises: one or more mold powder provision systems; one or more mold binder dispensing systems; one or more mold powder removal systems; and one or more molten metal processing systems; wherein the casting system is configured to additively produce multiple production layers in one or more build units, one currently-produced production layer after the other; wherein for each currently-produced production layer: the one or more mold powder provision systems are configured to provide one or more current mold powder layers; the one or more mold binder dispensing system are configured to form one or more current metal-facing zones of the mold regions within each of the one or more current mold powder layers by selectively dispending one or more binders that bond some mold powder particles of the current mold powder layer; the one or more mold powder removal systems are configured to remove mold powder particles located within a certain area of each of the one or more current mold powder layers, the certain area is defined by at least some of the one or more current metal facing zones of the mold regions; and the one or more molten metal processing systems are configured to form one or more current object regions of the currently-produced production layer by providing molten metal to the certain area.

The casting system may further comprise one or more movement systems for moving the one or more mold powder provision systems, one or more mold binder dispensing systems, one or more mold powder removal systems and one or more molten metal processing systems relative to the one or more build units, the casting system may further comprise a controller in data communication with the one or more mold powder provision systems, one or more mold binder dispensing systems, one or more mold powder removal systems, one or more molten metal processing systems, the movement systems and the one or more build units, the controller is configured to operate the one or more mold powder provision systems, one or more mold binder dispensing systems, one or more mold powder removal systems, one or more molten metal processing systems, the movement systems and the one or more build units in synchrony to concurrently produce one or more production layers at the one or more build units.

The controller may be configured to operate the one or more mold powder provision systems, one or more mold binder dispensing systems, one or more mold powder removal systems to produce mold regions of one production layer at the one or more build units while operating the metal processing system to produce the object region of another production layer at the one or more build units.

The height of each currently-produced production layer may be in a range of 1 millimeter to 20 millimeter. The height of the one or more current mold powder layers may be in a range of 100 microns to 150 microns. The height of the one or more current object regions is in a range of 1 millimeter to 20 millimeter.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram of an example of a casting system according to aspects of this disclosure;

FIGS. 2-3 illustrate examples of manufacturing of a currently-produced production layer;

FIG. 4 illustrates an example of various stages of forming one or more current object layers;

FIGS. 5-7 illustrate examples of manufacturing of a currently-produced production layer;

FIG. 8 is an example of a method for casting an object; and

FIGS. 9-14 illustrate examples of manufacturing of a currently-produced production layer.

### DETAILED DESCRIPTION OF THE PRESENT INVENTION

The metal additive manufacturing space is based, at large, on direct-deposition technologies and mold powder bed fusion technologies utilizing laser and electron beams. At industrial use are the following technologies: Laser-Based Mold powder Bed Fusion, Laser Mold powder Deposition, Electron Beam Mold powder Bed Fusion, Wire Electric/Plasma Arc Deposition, Wire Electron Deposition, Directed Energy Deposition (DED), and Metal Binder Jetting. Other direct deposition and sintered-based technologies are available at earlier stages of development and adoption.

Metal additive manufacturing approaches aim to enable complex design with high resolution and accuracy of the final part, obviate the need for mold preparation and use, expedite lead time, and elevate manufacturing safety.

Currently-available metal additive manufacturing technologies address complex design and low-volume applications of relatively small-size parts. For example, the print rate in laser mold powder bed technologies may fall between 0.1-0.3 Kg./hour and 0.5-3 Kg./hour for Binder Jetting technologies. Laser Mold powder Bed technologies are used to manufacture parts of about 10, 20, and 30 Kg, while Binder Jetting technologies are used for smaller pieces of about 1, 2, 5, and 10 Kg. Scaling from small parts to large parts of hundreds and thousands of Kg. is not trivial. In several currently available metal additive manufacturing technologies, size, and weight scaling involve part deformation, distortion, shrinking, fracture, cracking, and more.

Cost-per-part is relatively high, for example, about two orders (×100) for Laser Mold powder Bed technologies and an order (×10) for Binder Jetting technologies compared to traditional metal casting techniques.

Currently-available metal additive manufacturing technologies differ in their ability to manufacture near-net-shape parts and accuracy tolerances. The final piece may undergo surface treatment in some cases, often with other production processes and operations.

Mold powder-based techniques typically involve complex post-processing operations such as de-mold powdering, de-binding, and sintering. The formulation and manufacturing of metal mold powder add additional challenges. As a result, the overall complexity, cost, and throughput of mold powder-based techniques comparing non-mold powder techniques are higher.

Non-mold powder additive manufacturing technologies may facilitate the use of commercially-available, standard metal materials. As a result, part manufacturers can use materials they are familiar with—which may save lengthy qualifications of new materials—an advantage over mold powder-based techniques.

Despite the advantages of metal additive manufacturing, high cost, low throughput, and scaling challenges prevent the adoption of additive techniques for widespread industrial use, especially for manufacturing Iron and Steel parts.

The manufacturing of Iron and Steel parts holds about 70% of the metal manufacturing market. Iron and Steel manufacturing needs are addressed mainly by traditional metal casting technologies.

Casting is one of the oldest material-forming methods still used today. The principal process had not changed since 3200 BC when bronze was melted and poured into a stone mold. Metal casting is defined as the process in which molten metal is poured into a mold that contains a hollow cavity of a desired geometrical shape and is allowed to cool down to form a solidified part. The term ‘casting’ is also used to describe the part made by the casting process.

Traditional casting involves several production operations:
i. Patternmaking—a replica of the part to be cast is made using a suitable material such as wood, metal, plastic, or plaster;
ii. Mold making—mold making is a multi-operation process in which patterns and cores are used to create a mold. The type and how the molds are made vary depending on the type of metal casting. For example, sand casting uses sand inside a flask to create molds, and die casting uses hardened tool steel molds. Modern casting involves the use of expendable or permanent molds made from various materials, such as sand casting, die casting (e.g., a metallic mold), semi-die casting (e.g., metallic mold with sand inserts), investment casting (e.g., a ceramic shell mold), lost foam casting (e.g., relapsing polymeric foam with molten metal placed in a sand container) and the like;
iii. Metal melting and pouring—metal is melted and poured into the mold cavity by gravity or high pressure. High pressure is often needed to enable the filling of the entire part mold. In many cases, filling the entire part mold requires additional elements in the mold, such as pouring cups, runners, risers, and extensions. These additional elements may add up to ˜50% to the total metal casting volume. Further, the removal and scrapping of the additional elements add operational complexity to the post-processing treatment. After metal pouring, the cast is allowed to solidify before the cast parts are removed from the mold. A few heating and cooling cycles may be performed on the cast part, depending on its required properties; and
iv. Post-processing: in this operation, the cast metal object is removed from the mold and then fettled. Part removal will vary depending on the type of metal casting. During the fettling, the object is cleaned of any molding material, and rough edges are removed.

Traditional casting is widely used for industrial manufacturing of large production quantities and sizable parts in a one-piece cast. Metal casting can produce complex shapes, and features like internal cavities or hollow sections can be easily achieved. Materials that are difficult or expensive to manufacture using other manufacturing processes can be cast. Almost all metals can be cast. Compared to other manufacturing processes, traditional casting is cheaper for medium to large quantities.

Several disadvantages characterize modern traditional and additive metal casting.

Patterns and molds are time-consuming and expensive to make. Additive manufacturing processes, such as binder jetting, are used to create patterns and molds. However, the fabrication of patterns and molds extend the lead time and limit design flexibility for modifications and adaptations.

In some applications, the near-net shape is achieved without requiring further post-processing. For other applications, minor post-processing or significant additional post-processing operations are needed.

Metal casting is a hazardous activity. Workers' health and safety is an unsolved issue.

The manufacturing floor includes many elements, such as furnaces, molds, cooling areas, and additional tooling. Many metal casting machines and tools are manually operated—and are open. It is very hot when molten metal is transferred from the metal furnace by the pouring ladle to the mold. Temperatures will be in the region of 600, 800, 1000, 1200° C., and more. Specialist PPE (Personal Protective Equipment) and safety tests and reviews are a must. The production floor is also off-limits to unprotected personnel during any casting process.

One of the most significant safety hazards in any metal casting facility is the presence of moisture. If there is moisture in the furnace melting crucible, the pouring ladle, or the mold itself, this can cause highly energetic reactions as the moisture instantly turns to steam due to the heat of the metal. The production environment should be well-ventilated to prevent the build-up of any fumes.

Additional safety hazards are heat stress associated with working in a hot environment, burns, the impact of light radiation on eye safety, hazardous chemicals, exposure to Lead, Silica dust, and other materials, and more.

In spite of awareness and prevention operations taken, the metal casting industry continues to be challenged with higher injury rates than other manufacturing technologies.

(4) Metal casting is among the industrial activities that pollute the environment. Some of the environmental issues associated with metal casting are—the emission of harmful and poisonous gases such as CO2, dust, and particles and the generation of waste pollutants. Government and metal casting industry associations have set up several norms and guidelines to help the industry fight pollution by controlling emissions and proper disposal of contaminants.

Many Governments presented health, safety, and environmental legislation that significantly impacted the way foundries conduct their business and elevated associated costs.

According to embodiments of the invention, there are provided systems and methods for digitally planned and controlled additive metal casting. According to embodiments of the invention, the use of patterns is obviated. According to embodiments of the invention, the use of additional mold elements such as pouring cups, runners, risers, and extensions is obviated. According to embodiments of the invention, additive manufacturing concepts are implemented in a novel manner for casting.

Various techniques of metal object production by additive casting are described, for example, in PCT patent publications WO2019053712 (Lavi et-al.), WO22243921 (Weisz et al.), and WO2023002468 (Lavi et-al.), all commonly owned by the present Applicant and incorporated herein in their entirety. According to these techniques, a series of production layers are created, forming a vertical stack of production layers. The production layers include mold regions and object regions, fabricated in-situ. In each production layer, one or more mold regions are generated, and then, molten metal is deposited into object regions defined by the mold regions. The vertical stack of production layers, each comprising mold regions and object regions, is fabricated one currently-produced production layer after another. The fabrication of the object regions utilizes heating of a metal source (e.g., a metal rod, metal pebbles in crucibles) towards its melting temperature and above. The object regions may be heated before, during, and after metal deposition.

A currently-produced production layer is a layer having mold region/s and object region/s that is being produced during a production iteration. Once production of a currently-produced production layer is completed—the currently-produced production layer may be regarded as a previously-produced production layer.

According to embodiments of the present disclosure, the mold regions are produced by an improved binder-jetting additive manufacturing technique in-situ with additive metal casting. For example, a plurality of current mold layers, each of about 100 to 150 microns high, is fabricated to create a mold region of 1 to 20 millimeters in height. Molten metal is then deposited into the mold region in one or more metal deposition iterations.

The mold region/s of the currently-produced production layer may include, after mold powder provision, removal, and binding, a metal-facing zone of bonded mold powder, an external mold zone of loose mold powder that is external to the metal-facing mold zone, and a mold powder-free zone (denoted ‘certain area’) constituting the object region.

One or more current metal-facing zones of the mold regions are formed by selectively dispensing binders that bond some mold powder particles of a current mold powder layer. At least one part of the current mold powder layer—the certain area—is evacuated (depowdered) prior to metal deposition to allow the formation of one or more current object regions. The invention is not limited by the type of powder materials: ceramics, sand, composites, metals, and other powder materials may be used. The invention is not limited by the type of binders used. In some embodiments, to secure the appropriate working conditions for binder jetting, e.g., temperature, flow rate, and viscosity, the operational parameters of the binder jetting system are sensed and controlled. For example, the temperature of the binder jetting environment, material, and previously-produced mold regions and object regions are sensed and controlled. Components of the binder jetting system may be cooled as necessary.

Binder jetting was initially developed at the Massachusetts Institute of Technology in the late 1980s and commercialized by companies such as Soligen, Z Corporation, General Electric (GE), Hewlett-Packard (HP), ExOne, Voxeljet, Microjet, Desktop Metal, Digital Metal, and others. Binder jetting is used for many applications, including the moldless fabrication of metal parts and the fabrication of molds for sand casting. Binder-jetting additive manufacturing techniques are well documented and described, for example, in US patent publications U.S. Pat. No. 5,204,055 (Sachs et al.), U.S. Pat. No. 6,596,224 (Sachs et al.), and U.S. Pat. No. 9,878,494 (Hartmann et al.); and in (1) Du. W., Ren, X., Pei, Z., & Ma, C. (2020). Ceramic Binder Jetting Additive Manufacturing: A Literature Review on Density. Journal of Manufacturing Science and Engineering; and (2) Amir Mostafaci, Amy M. Elliott, John E. Barnes, Fangzhou Li, Wenda Tan, Corson L. Cramer, Pecyush Nandwana, Markus Chmielus (2021) Binder jet 3D printing-Process parameters, materials, properties, modeling, and challenges, Progress in Materials Science, Volume 119, 2021, 100707, ISSN 0079-6425.

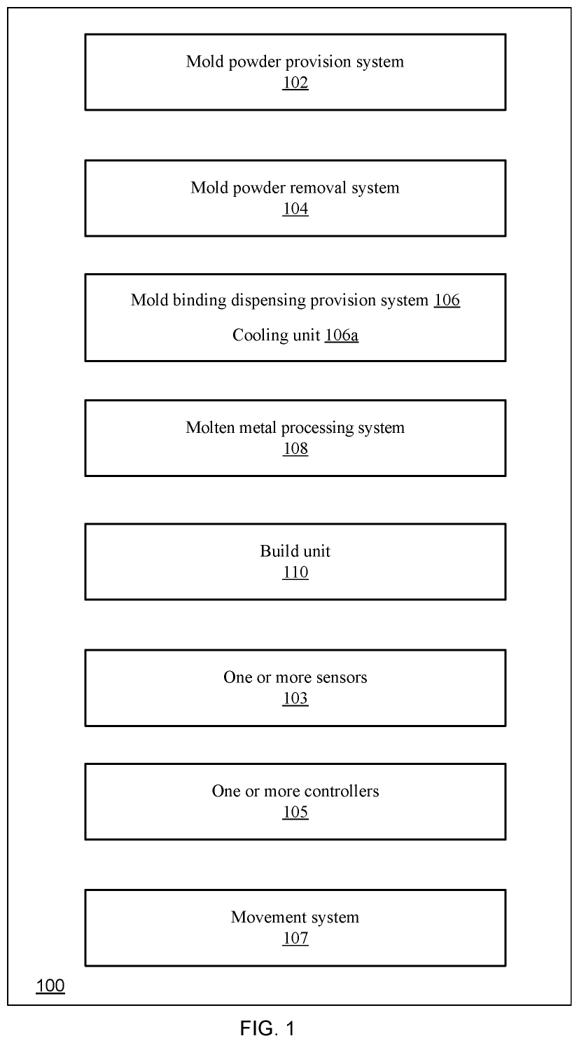

FIG. 1 is a block diagram of an example of a casting system 100.

Casting system 100 may include a mold powder provision system 102, a mold powder removal system 104, a mold binder dispensing system 106, and a molten metal processing system 108.

The casting system may also include a support unit such as a build unit 110, one or more sensors 103 for monitoring the operation of the casting system 100, one or more controllers 105 for controlling the operation of the casting system, and a movement system 107 for introducing movement between different systems and/or units and/or subsystems of the casting system.

Build unit 110 may comprise such main components as a build table, a build chamber, build environment (including environment, health and safety systems), operation stations and service systems.

The movement system may introduce movement between any system and/or unit or any components (for example, head) out of the mold powder provision system 102, the mold powder removal system 104, the mold binder dispensing system 106, the molten metal processing system 108 and the build unit 110. Any movement may be applied. The movements may be linear movements, non-linear movements, rotations, and the like.

In some embodiments, build unit 110 may be realized as one or more build tables of controllable height (Z direction). The movement system may introduce movement between various systems and elements of the casting system 100 across one or more build tables (X-Y plane) using known in-the-art techniques (e.g., X-Y gantry system, robotic system, and the like).

In some embodiments designed for the production of heavy and very heavy metal parts (e.g., in the range of 200 kg. to 1000 kg.), one or more build tables are stationary in the X-Y plane as well as in the Z direction.

The casting system 100 may be configured to additively produce multiple production layers, one currently-produced production layer after the other.

For at least some of the currently-produced production layers:
i. The mold powder provision system 102 is configured to provide a current mold powder layer.
ii. The mold binder dispensing system 106 is configured to form one or more current metal-facing zones of the mold regions within the current mold powder layer by selectively dispending one or more binders that bond some mold powder particles of the current mold powder layer.
iii. The mold powder removal system 104 is configured to remove mold powder particles located within a certain area of the current mold powder layer; the certain area is defined by at least some of the metal-facing zones of one or more current mold regions.
iv. The molten metal processing system 108 is configured to form one or more current object regions of the currently-produced production layer by providing molten metal to the certain area.

During fabrication, several heating-cooling cycles are implemented: the building environment (e.g., production chamber) may be maintained at desired temperature/s by chamber heaters and/or build tables heaters (not shown in FIG. 1). In some embodiments, the building environment is maintained at a first desired temperature during mold powder provision, a second desired temperature during mold binder dispensing, a third desired temperature during mold powder removal, and a fourth desired temperature during metal processing. The first, second, third, and fourth desired temperatures may differ from one another. For example, the first, second, and third desired temperatures may be in the range of room temperature up to 300 deg. Celsius; the fourth desired temperature may be in the range of 300 deg. Celsius up to 600 deg. Celsius, depending on the type of mold and metal materials. In some embodiments, the environment temperature is impacted by metal processing (grey iron, for example, is processed near or above its melting temperature, e.g., in the range of 1100-1600 deg. Celsius). Metal processing may involve object region heating by object region heaters (not shown in FIG. 1), to thereby (1) affect proper bonding between the previous metal layer and the current added metal, (2) affect the metallurgical and mechanical (stress relief) properties of the processed metal. In some embodiments, the transition from one desired temperature to another is implemented with no dedicated heating/cooling (for example, letting a previously-fabricated metal layer cool down). In other embodiments, dedicated heaters are used.

For each production layer of the multiple production layers (except—for example, a first production layer), the current mold powder layer is provided on a previously-produced production layer. A mold region in one production layer may be provided on top of the mold region of the previously-produced production layer (‘mold over mold’ production scenario). The mold region in one production layer may be provided on top of the object region of the previously-produced production layer (‘mold over metal’ production scenario (e.g., a raft)). The object region in one production layer may be provided on top of the object region of the previously-produced production layer (‘metal over metal’ production scenario, e.g., a block) or on top of the mold region of the previously-produced production layer (‘metal over mold’ production scenario, e.g., a bridge). The multiple layers may include a first production layer that is formed on a build table of the build unit.

Consequently, heating/cooling cycles are implemented to concurrently address considerations such as object material used (e.g., gray iron, ductile iron, and the like), proper bonding conditions, metallurgical properties conditions, stress relief conditions, and more.

During the metal processing phase, components such as the mold powder provision system 102, mold powder removal system 104, and mold binding dispensing provision system 106 are moved (for example, by movement system 107) to a side location. During the respective operational phase, the mold powder provision system 102, mold powder removal system 104, and mold binding dispensing provision system 106 are moved across the build table. Thus, the mold powder provision system 102, mold powder removal system 104, and mold binding dispensing provision system 106 are required to endure the various temperature changes occurring during casting and while placed at various locations.

In some embodiments, part or all of casting system 100, for example, part or all of the mold powder provision system 102, mold powder removal system 104, mold binding dispensing provision system 106, and movement system 107, are equipped with thermal shielding and/or cooling units. In some embodiments, the temperature of critical elements of the mold binding dispensing provision system 106 is dynamically maintained to thereby ensure the desired working conditions—binder temperature and viscosity. These embodiments will be discussed further below.

According to an embodiment of the disclosure, the mold powder removal system 104 may be configured to remove the mold powder particles from the certain area (depowdering) and optionally maintain a part (for example, a majority by weight and/or volume) of the mold powder particles of the current mold powder layer that are external to the metal facing side of the one or more current metal-facing zones of the mold regions (denoted ‘external mold zone’). The external mold zone may mechanically support one or more metal-facing zones of the current metal-facing zones of the mold regions—and even prevent one or more current metal-facing zones of the mold regions from collapsing.

The mold powder removal system 104 may provide a seal (hermetic seal or not) between the mold powder particles to be removed (for example, the mold powder particles from the certain area) and the mold powder particles that should not be removed (for example the mold powder particles outside the certain area). The seal may be a dynamic seal generated at least in part by one or more gas flows that propagate in one or more directions. An example of a dynamic seal is provided in U.S. Pat. No. 6,899,765 (Krivts et al.) and U.S. Pat. No. 9,997,328 (Rice et al.)—both being incorporated herein by reference.

For example—the mold powder removal system 104 may be configured to remove the mold powder particles from the certain area and prevent removing mold powder particles from the external mold zone.

According to an embodiment of the disclosure, the mold powder removal system 104 may include flow control elements that are configured to provide suction directly above the certain area and prevent suction directly above mold powder particles located outside the certain area.

Conventional binder jetting techniques employ depowdering after the complete structure of printed layers of the printed structure is cured and bonded together. Conventional binder jetting techniques do not depowder the build area during layer printing, as there is no need to do so. The loose powder may serve operational objectives such as mechanical support and thermal conductivity. In conventional binder jetting techniques, part designers need to consider depowdering aspects to ensure that all part segments will survive the mechanical stresses associated with depowdering. Powder exit paths should be designed to thereby ensure full powder removal in the vicinity of holes and cavities.

In performing powder removal between mold region fabrication and object region fabrication of the same production layer, the mechanical risks to the mold associated with depowdering are significantly reduced. The removal of powder in the vicinity of holes and cavities is considerably simplified. Therefore, part design limitations associated with depowdering are eased.

According to embodiments of the disclosure, the fabrication of the current layer starts with powder provision to the entire build area-on top of the previous fabrication layer. The current powder layer is thus provided on top of previous mold regions and previous object regions. In some embodiments, powder properties such as critical surface energy are considered with respect to object material properties. Preferably, powder material with lower critical surface energy (surface tension), compared to the critical surface energy of the object material, is selected. For example, sand, in general, has a lower critical surface energy than grey iron and ductile iron.

The dependency of the critical surface energy (surface tension) of the mold powder and object material is also considered, as both materials dynamically change their temperature during fabrication. In general, critical surface energy (surface tension) decreases when temperature increases. With a proper material selection, the mold powder particles will float over the previous object region during various production phases, and their removal is thus simplified. For example, mold powder particles will float over the previous object region if placed on e.g., grey iron and ductile iron at below-melting temperatures during cooldown and near-melting, melting and above-melting temperatures.

According to an embodiment of the disclosure, the mold binding dispensing provision system 106 comprises conventional components of a binder jetting 3D print head and related elements, including such major components as binder storage (e.g., a liquid binder cartridge), print head nozzles, and controllable nozzle actuators. Conventional print heads and related components may be used, with certain improvements and modifications, as will be discussed below.

As discussed above, the mold binding dispensing provision system 106 is required to endure, during its operation and while not in operation, the temperatures experienced while moving above or adjacent to previously-fabricated hot metal regions. For example, as the mold binding dispensing provision system 106 may be moved at a height of 1-3 mm over previously fabricated hot metal regions, the experienced temperature may reach 600, 800, 1000 deg. Celsius and above. Further, the heat distribution in various parts of the build environment may not be even or unified. The temperature of areas closer to the previously produced metal region and the metal processing system 108 may be higher than, e.g., the temperature at the side location.

In some embodiments, one or more of the components of the mold binding dispensing provision system 106 comprises thermal shielding.

The working temperature of conventional binder jetting printers and materials is typically in the range of room temperature to 200 deg. Celsius. Several commercially-available binder jetting printers operate in the range of 80-125 deg. Celsius with binder viscosity in the range of 8-20 centipoise. In the presence of higher and dynamically-changing temperatures, operational factors such as binder viscosity and flow rate are consequently dynamically changing. Stable and repeatable operational factors is a must for industrial scaling, quality, and manufacturing repeatability.

To address this challenge, in some embodiments, the mold binding dispensing provision system 106 comprises a cooling unit 106a. In some embodiments, the cooling unit is realized as a hollow tube enveloping part or all of the print head the mold binding dispensing provision system 106 (and optionally, additional components), with a cooling fluid (e.g., water) flowing there through. In some embodiments, a contact-based cooling technique is employed. Any known-in-the-art cooling technique that does not impact the placement of loose powder may be used. The cooling unit 106a further comprises tubing and a circulation mechanism (not shown). The cooling unit 106a is controlled by a controller (e.g., casting system controller, not shown) and configured to maintain the print head (and optionally additional components) at a conventional working temperature, e.g., in the range of 80-125 deg. Celsius.

In some embodiments, the controller controls the cooling unit 106a (e.g., by controlling the flow of the cooling fluid or by other known manners) based on temperature readings coming from one or more sensors that sense the temperature at one or more areas of the build environment. For example, the temperature below the print head of the mold binding dispensing provision system 106 may be continuously sensed. For another example, in the ‘mold over metal’ production scenario (raft), the temperature of the previously-produced metal region is sensed before and after powder provision for the raft printing.

In some embodiments, binder temperature and flow rate are monitored and controlled to thereby maintain the desired working conditions and, consequently, binder viscosity. For example, the binder dispensing flow rate may be dynamically controlled to thereby facilitate the desired binder temperature and viscosity. For example, commercially-available binder jetting printers operate with a binder viscosity of 8-20 centipoises. Binder temperature and print head temperature are key factors impacting binder viscosity.

According to an embodiment of the disclosure, the molten metal processing system 108 may be configured to form one or more current object regions of the currently-produced production layer by depositing a layer of molten metal in the certain area.

According to an embodiment of the disclosure, the molten metal processing system 108 may be configured to form one or more current object regions of the currently-produced production layer by performing a single molted metal deposition iteration to the certain area.

According to an embodiment of the disclosure, the molten metal processing system is configured to form the one or more current object regions of a currently-produced production layer by performing multiple molted metal deposition iterations to the certain area.

According to an embodiment of the disclosure, the molten metal processing system may be configured to form one or more current object regions of the currently-produced production layer by depositing multiple layers of molten metal in the certain area.

According to an embodiment of the disclosure, the metal processing system may be configured to form one or more current object regions of the currently-produced production layer by applying a Preparation-Deposition-Post (PDP) treatment for depositing the molten metal to the certain area. An example of a casting system that is configured to apply a PDP treatment is illustrated in PCT patent publication WO2022243921 (Weisz et al.), which is incorporated herein by reference.

According to an embodiment of the disclosure, the molten metal processing system may include at least one induction coil unit, and the movement system 107 may be configured to provide a relative movement between (i) a build unit and (ii) the molten metal processing system.

The movement system 107 may be configured to introduce the relative movement along a progression direction while at least one induction coil unit is configured to heat a portion of the molten metal processing system 108 to deposit metal in a sub-area of the certain area to form a currently-produced layer of molten metal and at least one of (1) pre-heat a sub-area of a previously-produced layer of molten metal, and (2) post-heat a sub-area of a currently-produced layer of molten metal.

According to an embodiment of the invention (not shown in FIG. 1), the metal processing system 108 may include a molten metal reservoir, for example, a crucible. The metal processing system may include a metal feeding system, for example, a metal rod.

According to an embodiment of the disclosure, metal processing system 108 may be configured to convert metal powder to molten metal. According to another embodiment of the disclosure, the metal processing system 108 may be configured to convert metal rods, bars, pebbles, or ingots to molten metal.

Various metal feed techniques, melting methods, and associated hardware elements may be used within the scope of this disclosure for the generation of molten metal that is applied by the metal processing system.

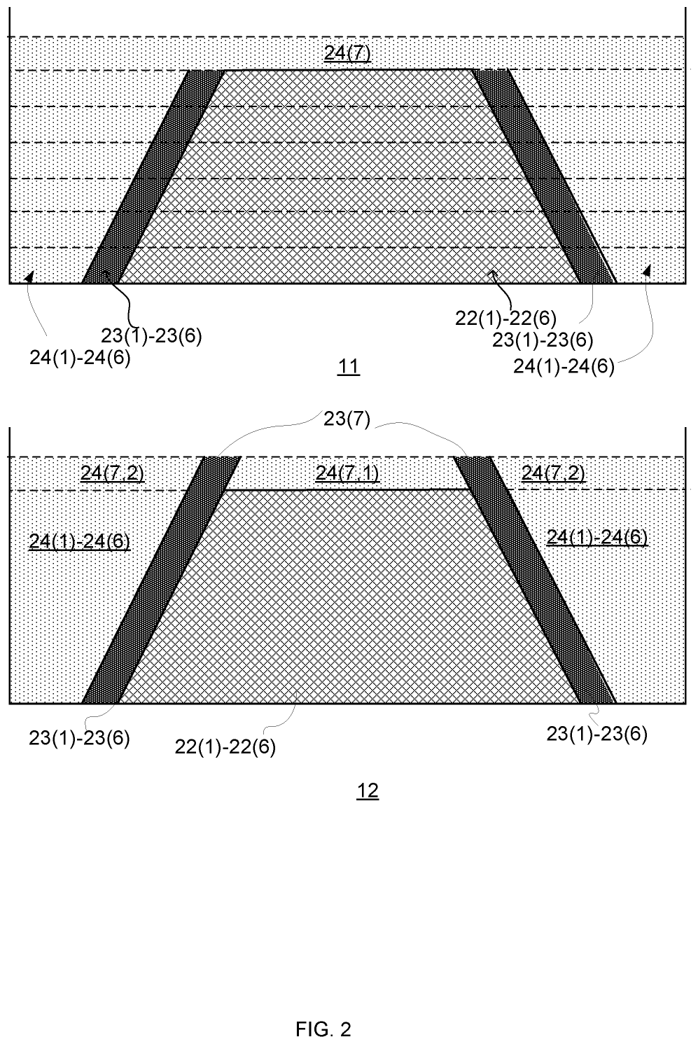

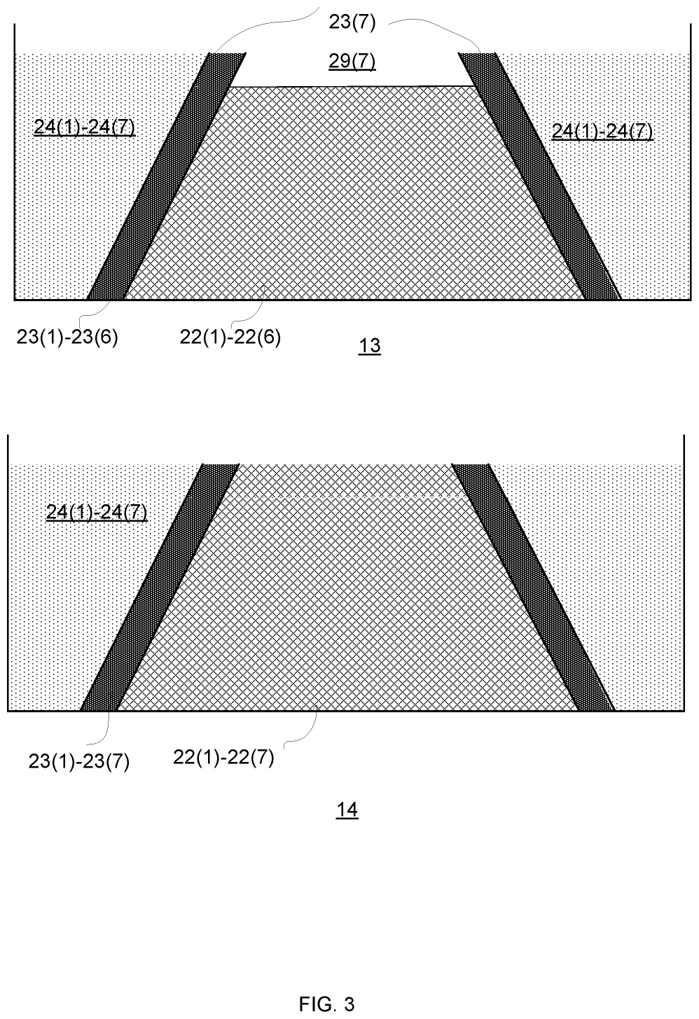

FIGS. 2-3 illustrate the manufacturing of a currently-produced production layer. It is assumed that the currently-produced production layer is the seventh production layer, and it is produced on top of six previously produced production layers.

Referring to FIG. 2—cross-section view 11 illustrates a formation of a current mold powder layer 24(7) above the six previously produced production layers. The six previously produced production layers include six previously-produced layers of object regions 22(1)-22(6), six previously-produced layers of metal-facing zones of mold regions 23(1)-23(6), six previously-produced layers of external mold powder layers (external to the six previously-produced layers of metal facing zones of the mold regions) 24(1)-24(6).

It should be noted that the reference to any of the six previously-produced layers is made for simplicity of explanation—as during the additive production process, the distinction between the different layers of the same type may disappear—for example, previously-produced object regions may merge. For simplicity of explanation, the virtual borders between previously generated production layers are omitted in some of the following figures.

Cross-sectional view 12 illustrates the formation of one or more current metal facing zones of mold regions 23(7) within the current mold powder layer (24(7) shown in cross sectional view 11) by selectively dispensing one or more binders that bond some mold powder particles of the current mold powder layer. The formation of one or more current metal facing zones of mold regions 23(7) segment the current mold powder layer 24(7) of cross-sectional view 11 to one or more external segments (one such segment 24(7,2) is shown in cross-sectional view 12) and to one or more internal segments 24(7,1) (one such segment 24(7,1) is shown in cross-sectional view 12). The reference to external and/or internal segments refers to the relationship to one or more current metal-facing zones of the mold regions (23(7)).

The term “external mold zome” relates to a zone near the metal non-adjacent side of the metal-facing zone. The term “internal mold zome” relates to a zone near the metal facing side of the metal-facing zone. The mold and object geometry, as illustrated in the drawings, is not limiting, and many mold and object geometries can be produced with systems and methods of the present disclosure.

For simplicity, a simplified, radial geometry is used to illustrate aspects of the present disclosure. Complex geometries can also be generated by embodiments of the invention. Such complex geometries involve the ‘mold over mold’, ‘mold over metal’, ‘metal over metal’ and ‘metal over mold’ production scenario. The mold region in one production layer may face metal in the same production layer, in the underlaying production layer or the next production layer.

The temperature of various areas of the current mold powder layer 24(7) may differ. For example, the loose powder external segments 24(7,2) may accumulate heat dissipating from other areas of the current mold powder layer 24(7) or from previously produced production layers. For another example, powder in the certain area 24(7,1) may accumulate more heat from the underneath previously produced metal region, as the temperature of the underneath previously produced metal region is higher than the temperature of loose powder 24(1)-24(6).

Referring to FIG. 3—cross-sectional view 13 illustrates the removal of mold powder particles located within a certain area (29(7)) of the current mold powder layer, the certain area is defined by at least some of one or more current metal facing zones of the mold regions. The internal segment 24(7,1) of cross-sectional view 12 was evacuated.

Cross-sectional view 14 illustrates the formation of one or more current object regions (22(7)) of the currently-produced production layer by providing molten metal to the certain area 29(7) of cross-sectional view 13.

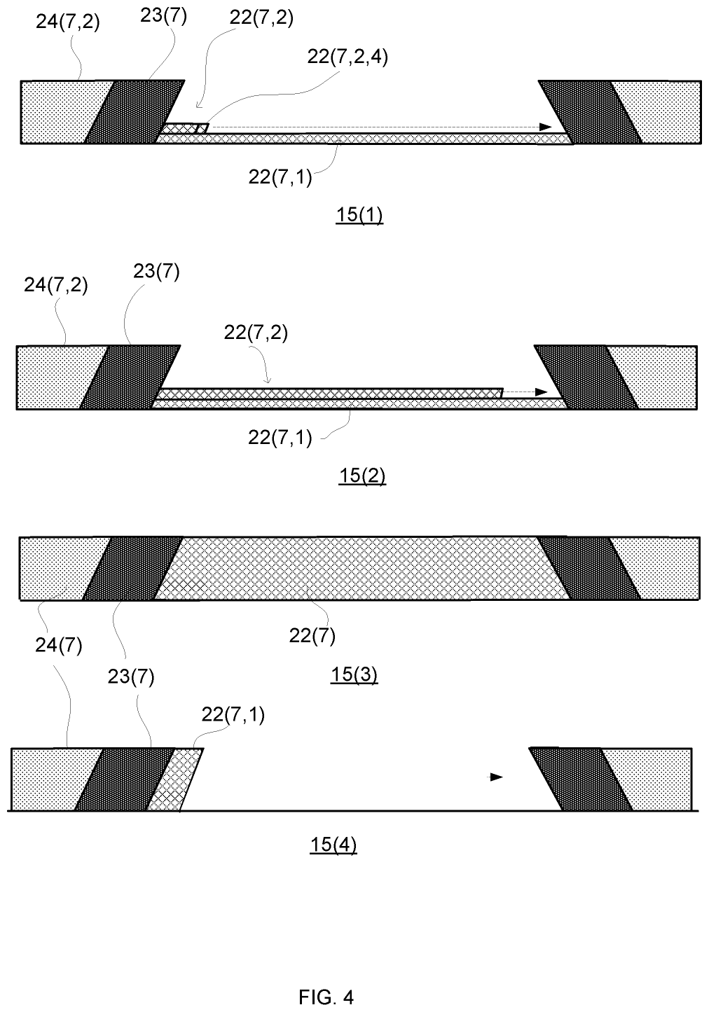

FIG. 4 illustrates an example of various stages of forming one or more current object layers.

View 15(1) illustrates a beginning of a formation of multiple layers of molten metal per one currently-produced production layer. One or more current metal-facing zones of the mold regions 23(7) are surrounded by external segments 24(7,2) of a current mold powder layer. A first layer of molten metal 22(7,1) was formed, and a second layer of molten metal 22(7,2) is starting to be formed—one sub-area (see, for example, sub-area 27(7,2,4) that is the last sub-area formed) after the other.

Cross-sectional view 15(2) illustrates further progress in the formation of the second layer of molten metal 22(7,2).

Cross-sectional view 15(3) illustrates the completion of a formation of one or more current object regions 22(7)—which is also a completion of a formation of the current production layer.

Cross-sectional view 15(4) illustrates a beginning of a formation of a single layer of molten metal per one currently-produced production layer according to another embodiment of the disclosure. See sub-area 22(7,1) of molten metal.

It should be noted that there may be any relationship between the number of mold layers and the number of molten metal layers.

The thickness of a molten metal layer may be selected to provide a molten metal layer of at least a predefined quality—for example, to obtain at least a predefined homogeneity. For example—the thickness of the molten metal layer may range between 0.1-20 millimeters, between 2-10 millimeters, and the like.

The thickness of a molten metal layer may be selected to provide a controlled and homogenous metal cooldown. For example, heat may be applied to the metal region of the currently-produced production layer. The heat may be controllably applied to the currently-produced layer 22(7, 1) or the currently-produced sub-area 27(7.2.4). The heat may dissipate into the previously produced object layers 22(1)-22(7).

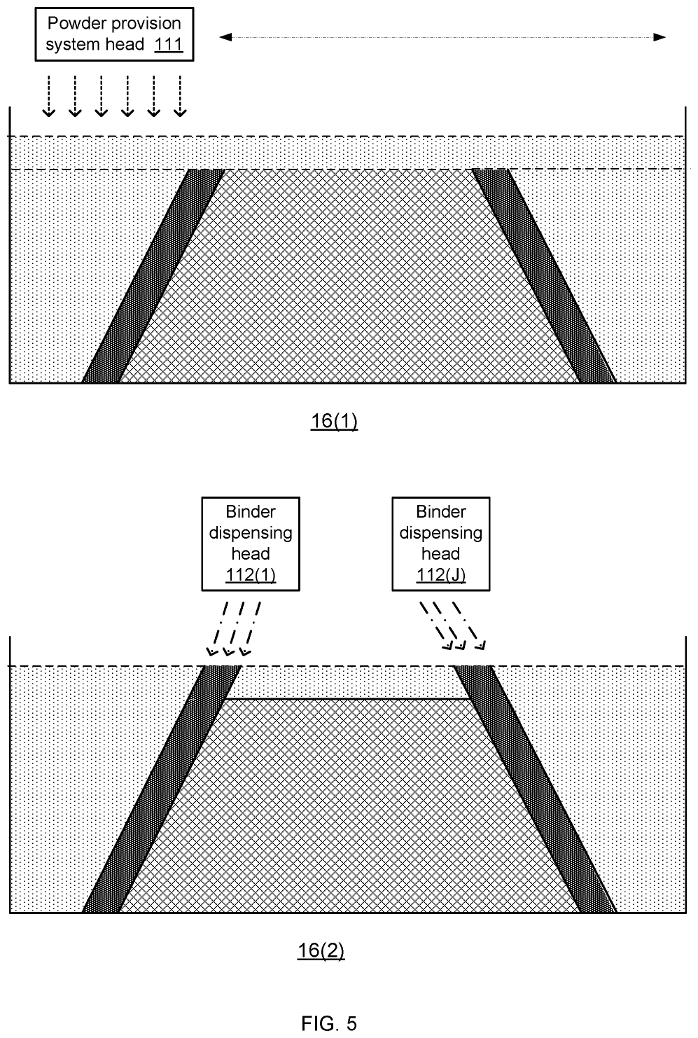

FIGS. 5-7 illustrate the manufacturing of a currently-produced production layer. It is assumed that the currently-produced production layer is the seventh production layer, and it is produced on top of six previously produced production layers.

Referring to FIG. 5—cross-sectional view 16(1) illustrates a provision of a current mold powder layer by a mold powder provision system head 111 (of the mold powder provision system 102 illustrated in FIG. 1) that may move along a spreading pattern. There may be more than a single powder provision system head. The powder provision system head may be static during the provision of the current mold powder layer.

Cross-sectional view 16(2) of FIG. 5 illustrates two mold binder dispensing heads 112(1) and 112(2) (of the mold powder provision system 102 illustrated in FIG. 1) that are configured to form one or more current metal-facing zones of the mold regions within the current mold powder layer by selectively dispensing one or more binders that bond some mold powder particles of the current mold powder layer. The mold binder dispensing heads 112(1) and 112(2) may move or may be static. There may be a single mold binder dispensing head or three or more mold binder dispensing heads.

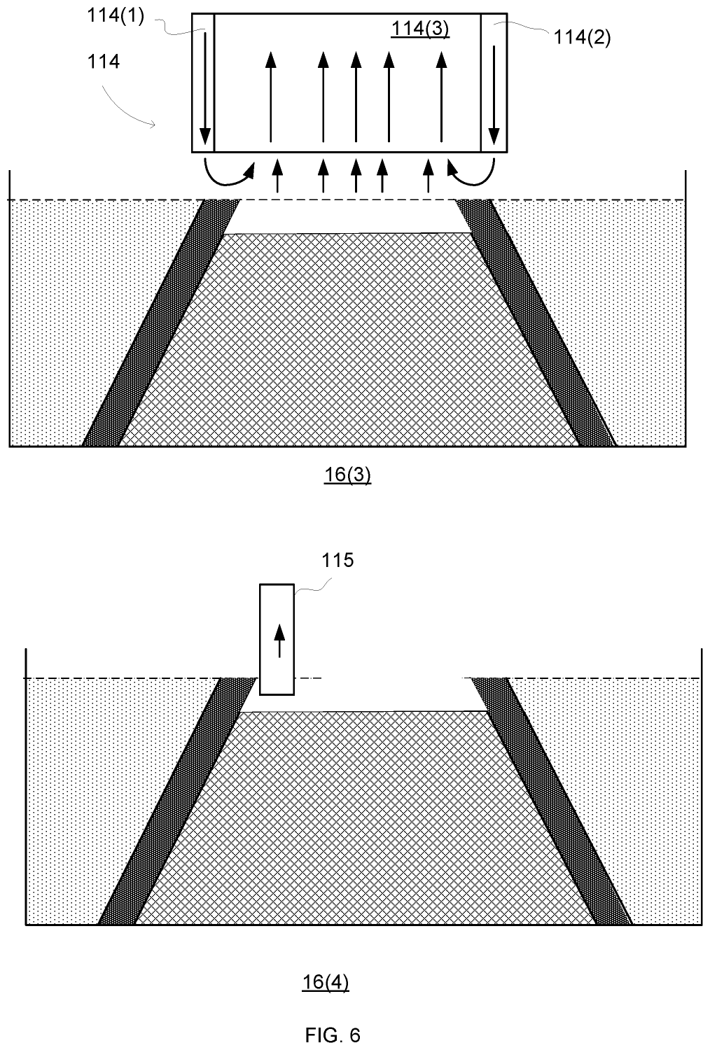

Referring to FIG. 6—Cross-sectional view s 16(3) and 16(4) illustrate two examples of mold powder removal system heads (114 and 115, respectively—of a mold powder removal system 104 shown in FIG. 1) that are configured to remove mold powder particles located within the certain area of the current mold powder layer, that constitutes the object region. There may be one, two, or more mold powder removal system heads.

In one example, shown in cross-sectional view 16(3), mold powder removal system head 114 includes a suction conduit 114(3) that is located between two air provision conduits 114(1) and 114(2). The suction applied by the suction conduit and the air provision conduits prevents the suction conduit from sucking the mold powder particles located to the sides of the mold powder removal system head 114. When positioning the suction conduit 114(3) above the certain area and positioning the two air provision conduits 114(1) and 114(2) above one or more metal-facing zones of the current mold regions—the mold powder removal system head 114 sucks the mold powder particles located within the certain area and is prevented from sucking the mold powder particles located outside the one or more current object regions. The mold powder removal system 104 may comprise one or more controllable suction conduits 114(3) and one or more air provision conduits 114(2). A flexible suction area can be achieved by selectively operating one or more controllable suction conduits 114(3) and one or more air provision conduits 114(2).

Mold powder removal system head 115 shown in view 16(4) includes a suction conduit that is configured to be lowered into the certain area during the suction. This reduces the chances of sucking mold powder particles located outside one or more current object regions.

A mold powder removal system head should apply suction over an area that does not exceed an area delimited by an exterior of the mold regions.

The powder removal system head 114 or 115 may be smaller than the area defined by the metal-facing zones of the mold regions.

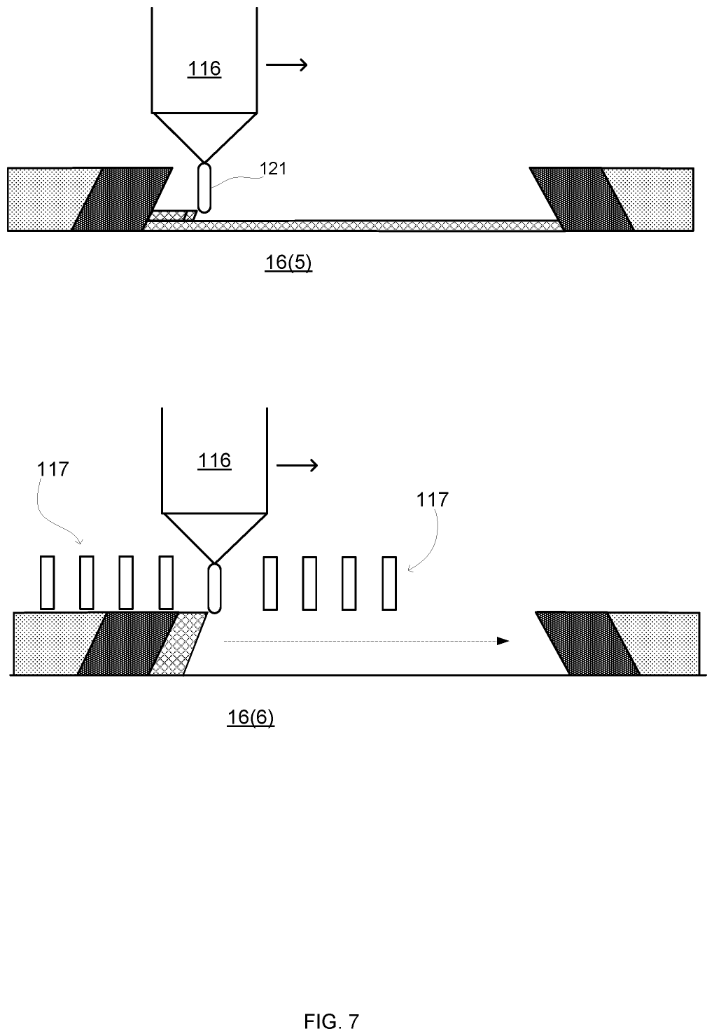

Referring to FIG. 7—cross-sectional view s 16(5) and 16(6) illustrate two examples of one or more elements of a molten metal processing system that are configured to form one or more current object regions of the currently-produced production layer by providing molten metal to the certain area.

In cross-sectional view 16(5), a molten metal processing system head 116 is at the start of generating a second layer of molten metal out of multiple layers of molten layer required for completing a single production layer. Cross-sectional view 16(5) also illustrates a drop 121 of molten metal.

In cross-sectional view 16(6), the molten metal processing system head 116 is at the start of generating a single layer of molten metal that is the single layer of molten layer required for completing a single production layer. Cross-sectional view 16(6) also illustrates a drop 121 of molten metal. Cross-sectional view 16(6) also illustrates multiple induction coil units 117 for heating at least the drop 121. The size, number, and locations of the multiple induction coil units may differ from those illustrated in Cross-sectional view 16(6). See, for example, PCT patent publication WO2022243921 (Weisz et al.).

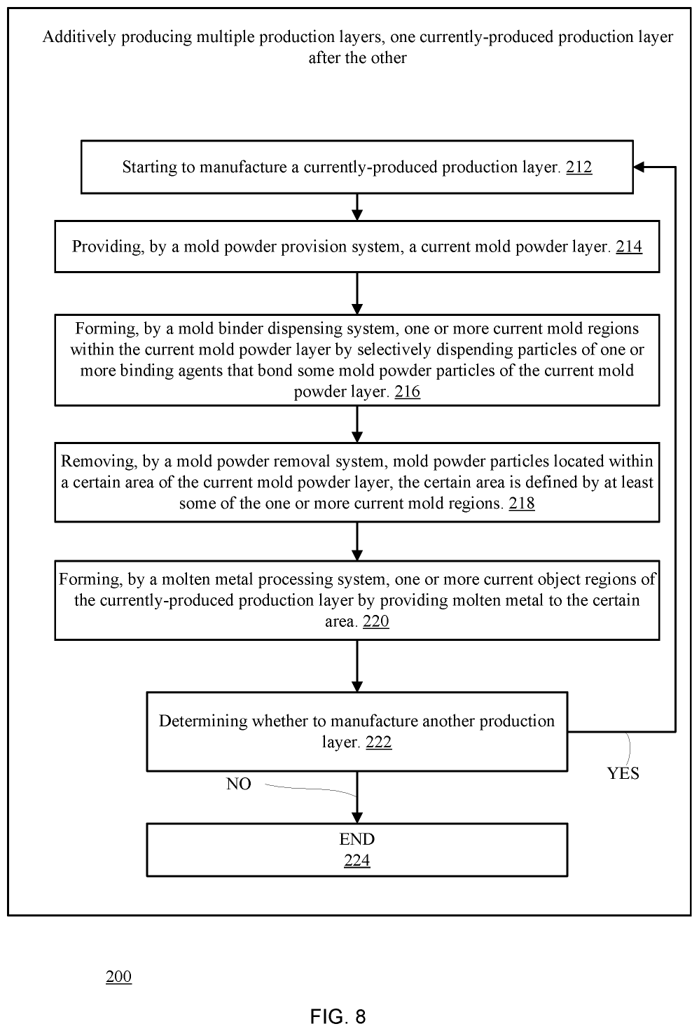

FIG. 8 is an example of method 200 for additively producing multiple production layers, one currently-produced production layer after the other.

Per a currently-produced production layer, there may be any number of current mold powder layers and any number of molten metal layers. There may be any relationship between the number of current mold powder layers and the number of molten metal layers.

Method 200 may be executed based on a plan for manufacturing a desired object. Method 200 may also include monitoring the production of the multiple production layers and making the required adjustments.

Method 200 may include steps 212-224.

Step 212 may include starting to manufacture a currently-produced production layer.

Step 212 may be followed by step 214 of providing, by a mold powder provision system, one or more current mold powder layers.

Step 214 may be followed by step 216 of forming, by a mold binder dispensing system, one or more current metal-facing zones of the mold regions within each of the one or more current mold powder layers by selectively dispensing one or more binders that bond some mold powder particles of the current mold powder layer.

A binder may be dispensed between mold powder layers or within the mold powder layers.

The binder may be fully cured or partially cured before the molted metal is provided. The molten metal may perform thermal curing of the binder.

The binder may be cured in any known manner—thermal curing. UV curing, interaction with gas curing—and the like.

Step 216 may include maintaining part or all of the elements of mold binder dispensing system at a desired working temperature. Step 216 may include receiving sensor readings coming from temperature sensors sensing the temperature at various areas of the build environment. For example, the temperature beneath binder dispensing heads 112 may be sensed. Additionally or alternatively, the temperature within binder dispensing heads 112 may be sensed. Step 216 may further include controlling the cooling of binder dispensing heads 112 in response to the received sensor readings.

Step 216 may be followed by step 218 of removing, by a mold powder removal system, mold powder particles located within a certain area defined by one or more current mold powder layers. The certain area is defined by at least some of the one or more current metal-facing zones of the mold regions.

Step 218 may include maintaining a portion (for example, at least a majority) of the mold powder particles of the one or more current mold powder layers that are external to the one or more current metal-facing zones of the mold regions.

Step 218 may include preventing from removal of mold powder particles from one or more current mold powder layers that are external to one or more current metal-facing zones of the mold regions.

Step 218 may include utilizing flow control elements to provide suction directly above the certain area and prevent suction directly above mold powder particles located outside the certain area.

Step 218 may be followed by step 220 of forming, by a molten metal processing system, one or more current object regions of the currently-produced production layer by providing molten metal to the certain area.

Steps 214-216 may be iterated as needed. For example, with the fabrication of a mold layer of 100-150 micron height, multiple iterations are required to generate a mold region of 4-12 millimeter height. Step 218 may be performed after the mold region of 4-12 millimeter height is generated, after interim iterations of steps 214-216, or after each iteration of steps 214-216.

Step 220 may include depositing a layer of molten metal in the certain area.

Step 220 may include performing a single molten metal deposition iteration to the certain area.

Step 220 may include performing multiple molten metal deposition iterations to the certain area.

Step 220 may include depositing multiple layers of molten metal in the certain area.

Step 220 may include applying a Preparation-Deposition-Post (PDP) treatment for depositing the molten metal to the certain area.

The PDP treatment may include introducing, by a movement system, a relative movement between (i) a build unit and (ii) the molten metal processing system.

The PDP treatment may include heating by at least one induction coil unit, and during the introduction of the relative movement, a portion of the molten metal processing system to deposit the molten metal in a sub-area of the certain area to form a currently-produced layer of molten metal, performing at least one of (1) pre-heating a sub-area of a previously-produced layer of molten metal, and (2) post-heating a sub-area of a currently-produced layer of molten metal.

Step 220 may include converting, by the metal processing system, metal mold powder to molten metal.

Step 220 may be followed by step 222 of determining whether to manufacture another production layer—and if so, jumping to step 212. Else—jumping to END step 224.

For each layer of the multiple production layers except the first production layer, the current mold powder layer is provided on a previously-produced production layer.

The multiple layers may include a first production layer that is formed on a build table of the build unit. The first production layer may be manufactured during the first iteration of steps 212-222.

After completing the production of the production layers at step 224, additional steps of a global nature may be implemented on the complete structure of stacked mold regions and object regions. Such additional steps of a global nature may include the depowering of loose powder from the external zones of the stacked mold regions; the removal of the bonded powder from metal-facing zones of the stacked mold regions, additional treatment for the stacked object regions such as surface treatment (polishing) and the like. These additional steps of a global nature may be performed using known in-the-art techniques.

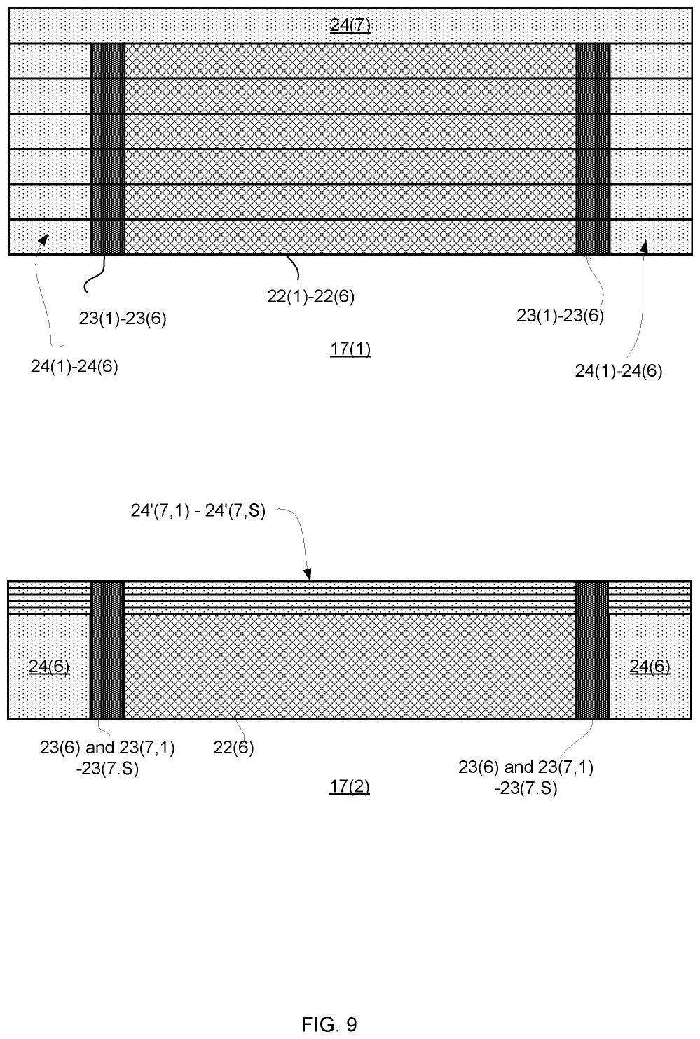

While FIGS. 2-7 illustrated the mold regions as being oriented towards the center of the production layers—the mold regions may be vertical or oriented towards the exterior of the production layers. FIGS. 9-11 and 13 illustrate vertical mold regions.

Referring to FIG. 9—view 17 1) illustrates a formation of a current mold powder layer 24(7) above six previously produced production layers. The six previously produced production layers include six previously-produced layers of object regions 22(1)-22(6), six previously-produced layers of metal-facing zones of mold regions 23(1)-23(6), six previously-produced layers of external zones of the mold powder layers (external to the six previously-produced layers of mold regions) 24(1)-24(6). The metal-facing zones of the mold regions are vertical.

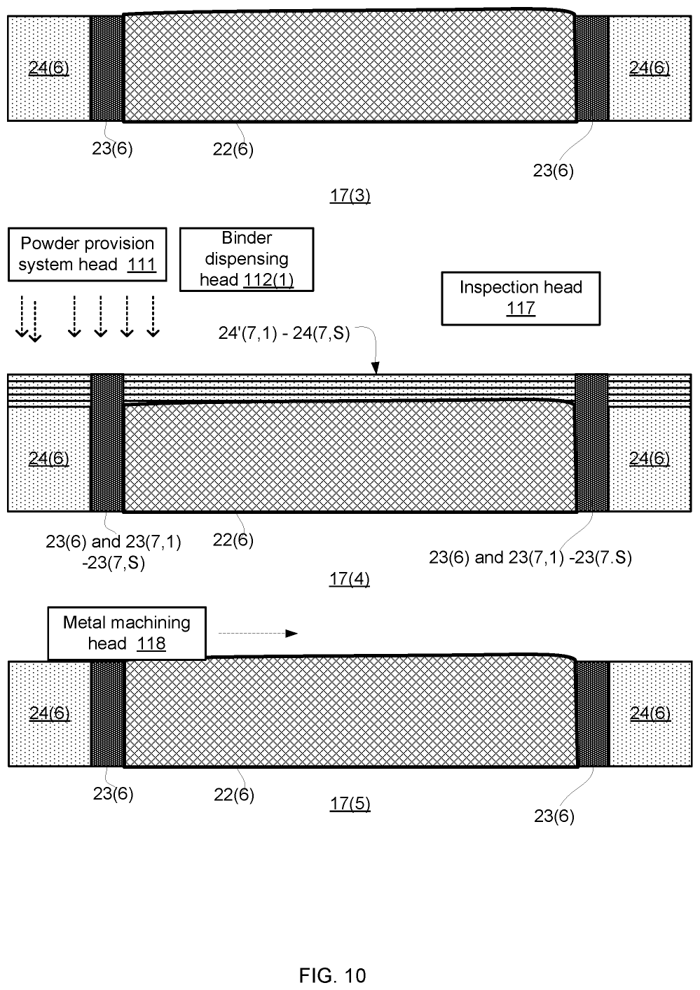

View 17(2) illustrates that multiple(S) mold powder layers 24′(7.1)-24′(7,S) are formed per each object layer. S is an integer that may exceed two. For example—a mold powder layer may have a thickness of about 100 to 150 microns, while the object layer may have a thickness of about 1-20 millimeters—especially 2-8 millimeters. The thickness of the mold powder layer should be small enough to allow the insertion of one or more binders of a desired viscosity and to keep the desired resolution and surface quality. The formation of each current mold powder layer is followed by formation of one or more current metal-facing zones of the mold region within the current mold powder layer-as illustrated with mold zones 23(6) and 23(7,1)-23(7.S), respectively. Metal-facing zones of the mold regions 23(6) and 23(7,1)-23(7,S) are also illustrated in view 17(4) of FIG. 10.

Referring to FIG. 10—cross-sectional view 17(3) illustrates that the upper surface of a previous object region is not smooth and horizontal. It is beneficial to have a smooth and horizontal top surface of the topmost mold powder layer—and this may be obtained by depositing the multiple mold powder layers in a controlled manner to ensure that the top surface of the topmost mold powder layer is smooth and horizontal—as illustrated in view 17(4) in which a powder provision system head 111 deposits mold powder under the control of inspection head 117 and binder dispensing head 112(1) dispenses one or more binders.

The inspection head may be included in the powder provision system head 111. Due to the curvature of the upper surface of a previous object region—there are gaps in one or more lower mold powder layers. It should be noted that the deposition of power mold may fill one or more recesses in a previous object region.

Additionally or alternatively—the upper surface of the previous object region may be machined to become smooth and horizontal—see, for example, view 17(5), in which a metal machining head 118 smooths the upper surface of the previous object region and makes it horizontal. This machining may include mechanical processing, heat treatment, evaporating some of the upper surface of the previous object region, and the like.

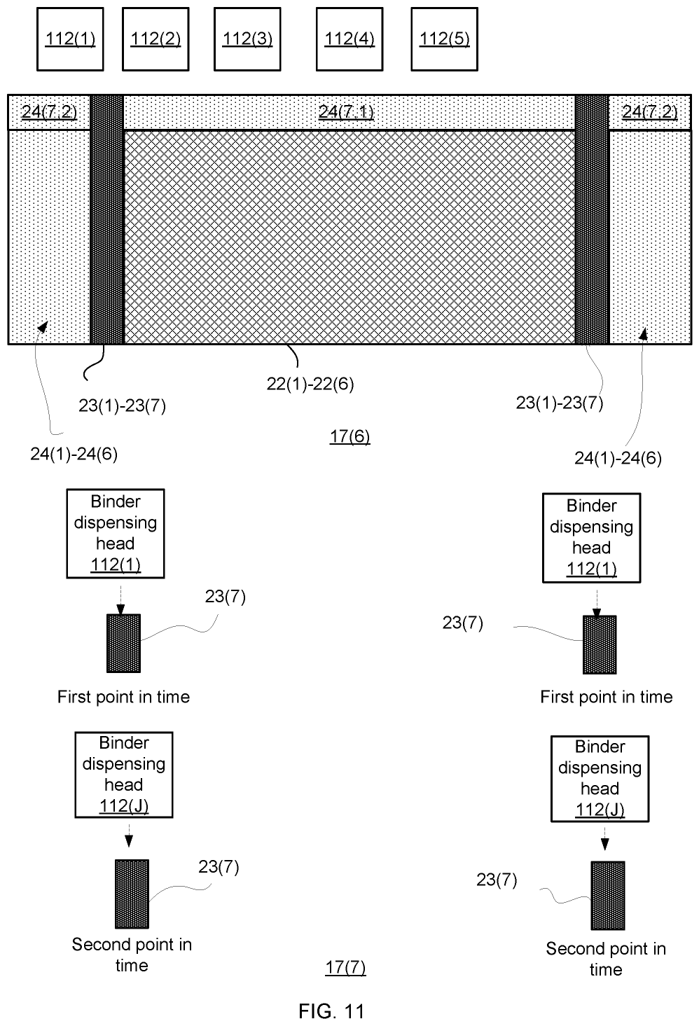

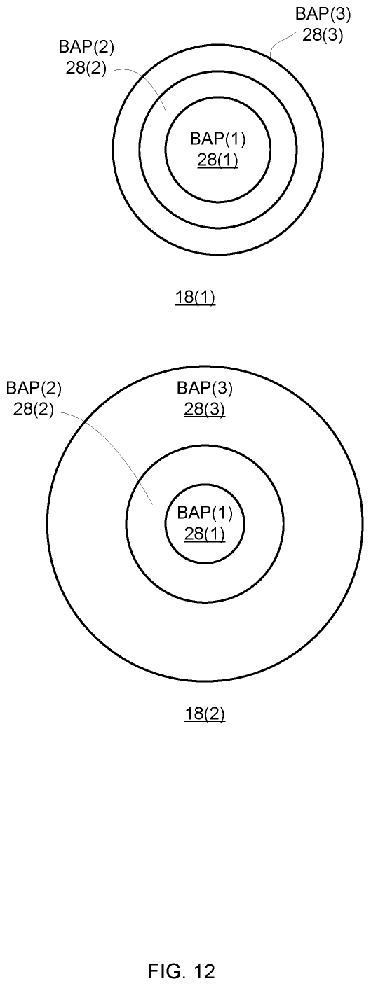

FIGS. 11 and 12 relate to the use of several binders.

A combination of binders can be provided. Two or more of the binders may differ from each other by any property—including, for example, chemical property, thermal property, and mechanical property.

One or more binders may be dispensed to provide desired cooling rates and/or cooling patterns of one or more object regions.

The mold binder dispensing system may be configured to deposit any number of binders—at one or more resolutions—for example, at the pixel or sub-pixel resolution or at coarser resolutions. For example—different binders may form different subzones. One subzone may be surrounded (fully or partially) by another subzone. One subzone may be contacted by another subzone and the like.

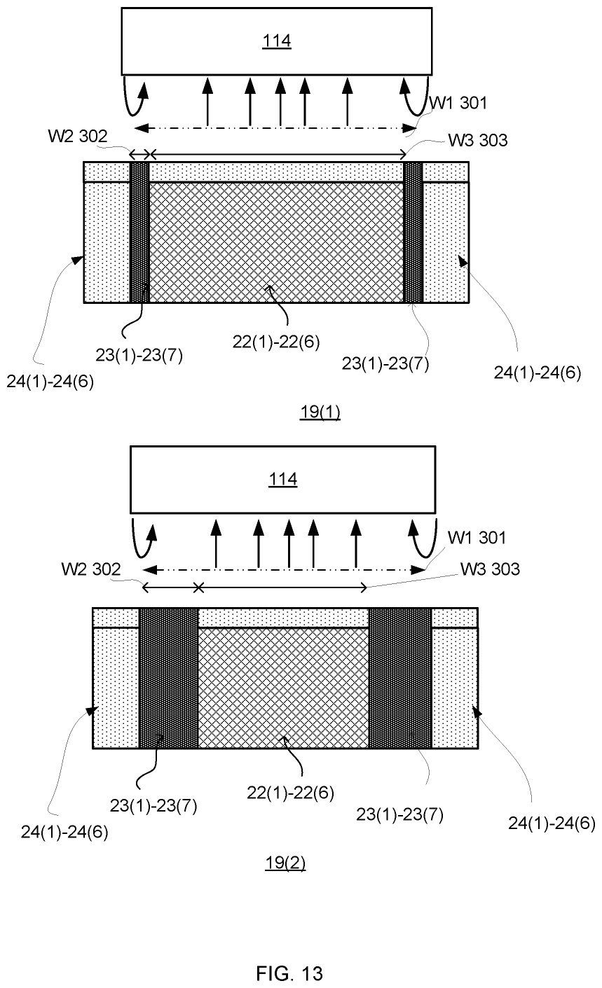

Any property of the mold region—including content and/or shape and/or size, may be controlled to obtain one or more desired goals. The desired goals may relate to any aspect of the production. The desired goals may be, for example, one or more desired cooling properties, one or more desired strengths, one or more mold powder removal properties (see, for example, FIG. 13), and the like.

The mold binder dispensing system may include any number of mold binder dispensing heads. Two or more mold binder dispensing heads may differ from each other by binders to be dispensed. One or more mold binder dispensing heads may dispense the same binder.

Two or more mold binder dispensing heads may dispense one or more mold binders in parallel to each other—or one after the other. zzz

Referring to FIG. 11—cross-sectional view 17(6) illustrates five mold binder dispensing heads 112(1)-112(5) that may dispense one or more binders. The five mold binder dispensing heads may dispense the same binder. At least two of the five mold binder dispensing heads may differ from each other by the binders they dispense. One mold binder dispensing head may dispense more than a single binder.

View 17(7) illustrates that two different mold binder dispensing heads 112(1) and 112(J) may dispense different binders at a different point in time to the same mold regions.

Top views 18(1) and 18(2) of FIG. 12 illustrate an example of a first binder subzone BAP(1) 28(1) (made of a first binder) that is surrounded by a second binder subzone BAP(2) 28(2) (made of a second binder) that is surrounded by a third binder subzone BAP(3) 28(3) (made of a third binder).

The binder subzones of top views 18(1) and 18(2) differ from each other by size.

The invention is not limited to specific binders, and many binding materials can be used for various applications. For example, metallic, ceramics, and other materials can be used. A variety of chemical properties (e.g., chemical resistance and the like), thermal properties (e.g., thermal durability, thermal resistance, and the like), and mechanical properties (e.g., compressive strength, tensile strength, and the like) may be used for various applications.

FIG. 13 illustrates two examples in which the width of the mold regions was adapted to comply with the suction pattern applied by the mold powder removal system head 114—to prevent the mold powder removal system head 114 from sucking loose mold powder outside the metal-facing zones of the mold regions. The mold powder removal system head 114 sucks mold powder from an area having a first width W1 301, each metal facing zone of the mold region has a second width W2 302, and the object region has a third width W3 303. The metal-facing zones of the mold regions should be shaped and sized to “cover” (along with the object region) the entire area (having the first width) being exposed to suction from the mold powder removal system head 114.

The object region of view 19(1) is wider than the object region of view 19(2)—which is compensated by having the metal-facing zones of the mold regions of view 19(2) wider than the mold regions of view 19(1).

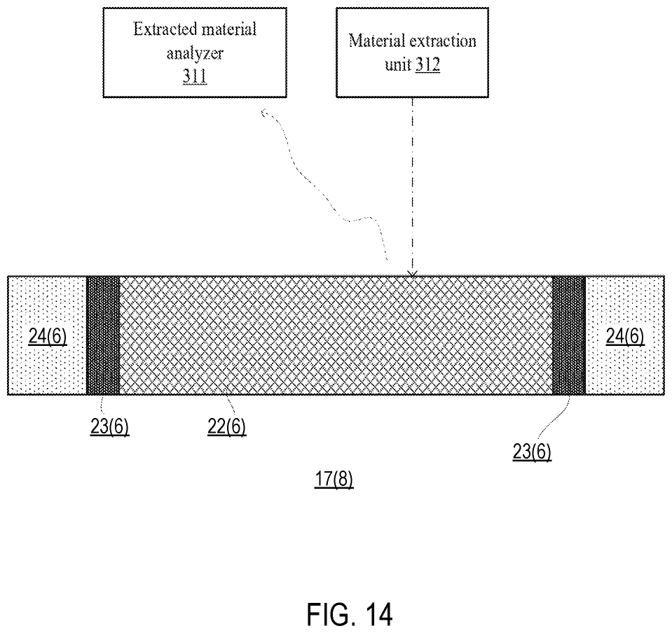

FIG. 14 illustrates an example of an object region 22(6) that has its material analyzed. A material extraction unit 312 may extract a portion of the object region (for example, by evaporating the portion of the object region using radiation (light, X-ray) or mechanical means), whereas the extracted portion reaches an extracted material analyzer 311 that may perform material analysis—for example by applying a spectroscopy process.

The information obtained by the material analyzer may be used for controlling the manufacturing process. For example, adjust the formation pace of the object region, adjust the formation temperature, adjust the chemical properties of the molten metal to be dispensed, and the like.

For ease of explanation, the described embodiments relate to a casting system 100 (FIG. 1) comprises a single mold powder provision systems 102, a single mold powder removal systems 104, a single mold binder dispensing systems 106, and a single molten metal processing systems 108. To improve throughput, in some embodiments, the casting system 100 comprises one or more mold powder provision systems 102, one or more mold powder removal systems 104, one or more mold binder dispensing systems 106, and one or more molten metal processing systems 108 and is configured to operate each of these systems in synchrony at different areas of one or more build tables. For example, the mold powder provision system 102, the mold powder removal system 104, and the mold binder dispensing system 106 are operated in synchrony to produce the mold regions of a first production layer on one build table, while the molten metal processing system 108 is concurrently operated to produce the object region of a second production layer on a second build table.

As used throughout the specification, the terms “metal” or “metallic” refers to any metals and/or mellitic alloys which are suitable for melting and casting, for example, ferrous alloys, aluminum alloys, copper alloys, nickel alloys, magnesium alloys, and the like.

In the outlined detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may, for the most part, be implemented using electronic components and circuits known to those skilled in the art, details will not be explained to any greater extent than that considered necessary, as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer-readable medium that stores instructions that once executed by a computer result in the execution of the method.

Any reference in the specification to a system should be applied mutatis mutandis to a method that may be executed by the system and should be applied mutatis mutandis to a non-transitory computer-readable medium that stores instructions that may be executed by the system.

Any reference in the specification to a controller should be applied mutatis mutandis to a computerized system in data communication with other system elements, capable of executing instructions stored in a non-transitory computer-readable medium, and/or to a computer program for running on a computer system, at least including code portions for performing steps of a method according to the invention when run on a programmable apparatus. A computer program is a list of instructions, such as a particular application program and/or an operating system. The computer program may, for instance, include one or more of: a subroutine, a function, a procedure, an object method, an object implementation, an executable application, an applet, a servlet, a source code, an object code, a shared library/dynamic load library and/or other sequences of instructions designed for execution on a computer system.

The terms “external”, “internal”, “front,” “back,” “top,” “bottom,” “over,” “under,” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other geometrical relationships and orientations than those illustrated or otherwise described herein.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected” or “operably coupled,” to each other to achieve the desired functionality.

Those skilled in the art will recognize that boundaries between the above-described operations are merely illustrative. The multiple operations may be combined into a single operation; a single operation may be distributed in additional operations, and operations may be executed at least partially overlapping in time. Moreover, alternative embodiments may include multiple instances of a particular operation, and the order of operations may be altered in various other embodiments.

In the claims, any reference signs placed between parentheses shall not be construed as limiting the claim. The word ‘comprising’ does not exclude the presence of other elements or steps than those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

Certain features of the invention have been illustrated and described herein. However, other modifications, variations, and alternatives are also possible. The specifications and drawings are, accordingly, to be regarded in an illustrative rather than in a restrictive sense. Many modifications, substitutions, changes, and equivalents will now occur to those of ordinary skill in the art. It is, therefore, to be understood that the appended claims are intended to cover all such modifications and changes as fall within the true spirit of the invention.

1. A casting system for casting an object, wherein the system comprises:
a mold powder provision system;
a mold binder dispensing system;
a mold powder removal system; and
a molten metal processing system;
wherein the casting system is configured to additively produce multiple production layers in a build unit, one currently-produced production layer after the other;
wherein for each currently-produced production layer:
the mold powder provision system is configured to provide one or more current mold powder layers;
the mold binder dispensing system is configured to form one or more current metal-facing zones of the mold regions within each of the one or more current mold powder layers by selectively dispending one or more binders that bond some mold powder particles of the current mold powder layer;
the mold powder removal system is configured to remove mold powder particles located within a certain area of each of the one or more current mold powder layers, the certain area is defined by at least some of the one or more current metal facing zones of the mold regions; and
the molten metal processing system is configured to form one or more current object regions of the currently-produced production layer by providing molten metal to the certain area.

2-5. (canceled)

6. The casting system according to claim 1 wherein a height of the one or more current object regions is in a range of 1 millimeter to 20 millimeter, and wherein a height of the one or more current mold powder layers is in a range of 100 microns to 150 microns.

7. The casting system according to claim 1 wherein the mold powder removal system is configured to remove the mold powder particles from the certain area and maintain loose mold powder at one or more external zones which are external to the one or more current metal facing zones of the mold regions.

8. (canceled)

9. The casting system according to claim 1 wherein the mold powder removal system comprises flow control elements that are configured to provide suction directly above the certain area and prevent suction directly above loose mold powder located outside the certain area.

10. The casting system according to claim 1 wherein the mold powder removal system comprises a suction conduit that is configured to be lowered into the certain area during powder suction.

11-21. (canceled)

22. The casting system according to claim 1 wherein at least one of the mold powder provision system, mold binder dispensing system and the mold powder removal system is thermally shielded at least in part.

23. The casting system according to claim 1 further comprising a controller in data communication with at least the mold powder provision system, mold binder dispensing system, the mold powder removal system, the molten metal processing system and the build unit, wherein at least one of the mold powder provision system, mold binder dispensing system and the mold powder removal system is equipped with a controllable cooling unit, and wherein the controller is configured to dynamically control the controllable cooling unit responsive to temperature sensor readings of one or more areas of the build unit.

24. The casting system according to claim 1 further comprising a controller in data communication with at least the mold powder provision system, mold binder dispensing system, the mold powder removal system, the molten metal processing system and the build unit, wherein the controller responsive to readings of one or more temperature sensors sensing one or more temperatures of one of the certain area and the metal facing zone of the mold region.

25-28. (canceled)

29. The casting system according to claim 1 wherein the mold binder dispensing system comprises one or more binder print heads and one or more binder storages, each binder storage is in fluid communication with at least one of the one or more binder print heads.

30-33. (canceled)

34. The casting system according to claim 29, further comprising a controller in data communication with at least the mold powder provision system, mold binder dispensing system, the mold powder removal system, the molten metal processing system and the build unit, wherein the controller is responsive to readings of a temperature sensor sensing a temperature beneath the one or more print heads.

35. (canceled)

36. A method for casting an object, wherein the method comprises:
additively producing multiple production layers, one currently-produced production layer after the other; wherein for each currently-produced production layer:
providing, by a mold powder provision system, one or more current mold powder layers;
forming, by a mold binder dispensing system, one or more current metal-facing zones of the mold regions within each of the one or more current mold powder layers by selectively dispending one or more binders that bond some mold powder particles of the current mold powder layer;
removing, by a mold powder removal system, mold powder particles located within a certain area of the one or more current mold powder layers, the certain area is defined by at least some of the one or more current mold regions; and
forming, by a molten metal processing system, one or more current object regions of the currently-produced production layer by providing molten metal to the certain area.

37-39. (canceled)

40. The method according to claim 36 wherein a height of the one or more current object regions is in a range of 1 millimeter to 20 millimeter and wherein a height of the one or more current mold powder layers is in a range of 100 microns to 150 microns.

41. (canceled)

42. The method according to claim 36 wherein the removing of the mold powder particles from the certain area comprises maintaining loose mold powder at one or more external zones which are external to the one or more current metal facing zones of the mold regions.

43. (canceled)

44. The method according to claim 36 wherein the removing of the mold powder particles from the certain area comprises utilizing flow control elements to provide suction directly above the certain area and prevent suction directly above loose powder located outside the certain area.

45-55. (canceled)

56. The method according to claim 36 further comprising thermally shielding at least one of the mold powder provision system, mold binder dispensing system and the mold powder removal system at least in part.

57. The method according to claim 36 further comprising cooling at least one of the mold powder provision system, mold binder dispensing system and the mold powder removal system by a controllable cooling unit.

58-63. (canceled)

64. The method according to 57, wherein the cooling comprises responding to readings of a temperature sensor sensing a temperature beneath one or more print heads of the binder dispensing system.

65. The method according claim 57, wherein the cooling comprises responding to readings of one or more temperature sensors sensing one or more temperatures of one of the certain area and the metal facing zone of the mold region.

66. A non-transitory computer readable medium for casting an object, wherein the non-transitory computer readable medium stores instructions for:
additively producing multiple production layers, one currently-produced production layer after the other; wherein for each currently-produced production layer:
providing, by a mold powder provision system, one or more current mold powder layers;
forming, by a mold binder dispensing system, one or more current metal-facing zones of the mold regions within each of the one or more current mold powder layers by selectively dispending particles of one or more binders that bond some mold powder particles of the current mold powder layer;
removing, by a mold powder removal system, mold powder particles located within a certain area of the one or more current mold powder layers, the certain area is defined by at least some of the one or more current mold regions; and
forming, by a molten metal processing system, one or more current object regions of the currently-produced production layer by providing molten metal to the certain area.

67-69. (canceled)

70. The casting system according to claim 1 further comprising a movement system configured to introduce relative movements between at least (1) the mold powder provision system, mold binder dispensing system and the mold powder removal system and (2) the build unit.
